(19) United States
(12) Patent Application Publication
(10) Pub. No.: US 2012/0297457 A1
(43) Pub. Date: Nov. 22, 2012

(54) Interactive Malware Detector

(76) Inventors: Brian Schulte, vienna, VA (US); Angelos Stavrou, Springfield, VA (US); Anup K. Ghosh, Centreville, VA (US); Rhandi Martin, St. James, WI (US); Charalampos Andrianakis, Fairfax, VA (US)

(21) Appl. No.: 13/296,319

(22) Filed: Nov. 15, 2011

Related U.S. Application Data
(60) Provisional application No. 61/413,677, filed on Nov. 15, 2010.

(51) Int. Cl. G06F 21/00

(52) U.S. Cl. 726/4

(57) ABSTRACT

An interactive detector that includes a challenger and authorizer. The challenger may send a challenge to a source application in response to an intercepted request intended for a destination application from the source application. The challenge may be configured to invoke an expected challenge response from component(s) of the source application. The authorizer may allow the request to proceed to the destination application if a received challenge response generated by the source application satisfies the expected challenge response.

### CROSS-REFERENCE TO RELATED APPLICATIONS

This application claims the benefit of U.S. Provisional Application No. 61/413,677, filed Nov. 15, 2010, entitled “Network Traffic Analysis,” which is hereby incorporated by reference in its entirety.

### STATEMENT REGARDING FEDERALLY SPONSORED RESEARCH OR DEVELOPMENT

This invention was made with government support under STTR grant number 201 973 awarded by the Army Research Office. The government has certain rights in the invention.

### BRIEF DESCRIPTION OF THE SEVERAL VIEWS OF THE DRAWINGS

FIG. 1 is a flow diagram of an HTTP or SIP request through an aspect of an example embodiment of the present invention.

FIG. 2 is a block diagram showing the processing of an HTTP GET/POST request as per an aspect of an example embodiment of the present invention.

FIG. 3 is a diagram of an active challenge of an HTTP/S Client as per an aspect of an example embodiment of the present invention.

FIG. 4 is a diagram of a SIP call with interactive challenge as per an aspect of an example embodiment of the present invention.

FIG. 5 is a table of example HTTP header element orders.

FIG. 6 is a table of example SIP INVOTE header element orders.

FIG. 7A and FIG. 7B are plots showing results of 604 zero-day malware.

FIG. 8 is a plot showing the overhead introduced by an HTTP challenge architecture as per an aspect of an example embodiment of the present invention.

FIG. 9A and FIG. 9B are plots comparing File Download Architectures.

FIG. 10 is a chart showing the overhead introduced by a SIP challenge as per an aspect of an example embodiment of the present invention.

FIG. 11 is a table of example SIP method and challenges and functions as per an aspect of an example embodiment of the present invention.

FIG. 12 is a table of example SIP method responses as per an aspect of an example embodiment of the present invention.

FIG. 13 is a table of processing times of example challenge conversations as per an aspect of an example embodiment of the present invention.

FIG. 14 is a block diagram of an interactive detector as per an aspect of an example embodiment of the present invention.

FIG. 15 is a block diagram of an interactive detector as per an aspect of an example embodiment of the present invention.

FIG. 16 is a flow diagram of an interactive malware detector process as per an aspect of an embodiment of the present invention.

### DETAILED DESCRIPTION OF EMBODIMENTS

Some embodiments of the present invention issue Program Interactive Challenges (PICs) to client applications to distinguish between legal applications from malware. Additional embodiments of the present invention may also employ passive detection to distinguish between legal applications from malware. For example, passive detection may analyze header element orders to distinguish between legal applications from malware.

The proliferation of malware may increase incidences of theft of personal information, intellectual property, and classified and other sensitive data. Enterprises may need to pay added attention to outgoing traffic, particularly communications over ubiquitous ports and protocols. Traditional firewalls may be ineffective. Packet filtering may only be effective against atypical ports, while web browsing (e.g. HTTP, HTTPS) and, increasingly, VoIP ports may be allowed by default.

Other methods to police traffic may also have inadequacies. Blacklisting and static, signature-based detection may often be only as good as the up to datedness of malicious site databases. While content-filtering and inspection may provide a simple, fast and scalable method of vetting network traffic, content engines may rely too heavily on the validity of the client-supplied user-agent field in identifying which client generated a request packet. Anomaly-based detection approaches may discover inconsistent behavior and malicious data, but may not prevent data exfiltration through well-formed requests. While some payload inspecting mechanisms may be better with zero-day attacks, in general, most security mechanisms may only be selectively applied. Client(s) that passes inspection may exfiltrate data in a minimum number of packets or complete a request to download a file. As such, some embodiments of the present invention may question the veracity of requests.

A challenge in developing robust malware detection solutions may be to develop fast, scalable, real-time systems that may detect misuse, protocol deviation and malicious downloads. A contemporary approach to content-based client identification may be defeated by falsifying browser configuration items or by setting a user-agent field of HTTP request packets.

To address inadequacies of contemporary detection systems, some embodiments of the present invention may employ passive detection and/or active detection to detect malware. According to some embodiments, passive detection may pre-screen traffic to defeat simple malware that masquerades as legitimate clients. Passive client identification may, for example, focus on high-speed packet analysis such as analyzing the order of header elements in packets generated by a particular client.

For active detection, some embodiments may focus on client-side queries that may be real-time, transparent and/or non-disruptive to communications. For example, some embodiments may employ an architecture in which a gateway device may challenges an application to prove itself to defeat more complex malware masquerading as legitimate clients. Some embodiments may not require user interaction. Furthermore, some embodiments may pre-empt download request(s) until components of a legitimate browser or SIP application correctly decode a challenge. Active mechanisms may distinguish web and VoIP applications from malware with low overhead. Some embodiments may employ a proactive alternative for preventing malicious downloads to prevent zero-day attack solutions with more resilience than with blacklisting or signature based detection.

Some embodiments may employ passive detection mechanisms that may derive unique signature(s) (e.g. Perl regular expressions) for legitimate application(s) using name(s), version(s) and operating system(s). Some embodiments may employ a more complete dataset of signatures using device name(s) and version(s). However, applications may share engines and libraries such that applications on different operating systems, or different applications using the same engine or library, may produce message headers with indistinct element orders. Furthermore, the same application version may differ in packet structure for different operating systems. Therefore, some embodiments may form more fine-grained signature(s) to yield further information about application(s) while avoiding high false negative rates due to over-specificity. To balance granularity, accuracy and usability for a large dataset of applications and message requests, some embodiments may be limited subsets of protocols such as to HTTP GET and POST, and SIP INVITE packets.

Some embodiments may process message headers of request packets, however, encrypted connections may obscure these packets. Some embodiments may act as a man-in-the-middle in order to decrypt and analyze these communications.

Some embodiments may assume that a client machine is infected with malware even though application(s) (e.g. browser or VoIP) have been altered. Such malware may be user activated by mouse-click(s) or the like. Upon execution, malware may attempt to: a) post information to an external site, b) load a webpage or popup, or c) download additional binaries to a victim machine, or the like. Some malware may not form connections immediately upon execution, but may wait for an indeterminate amount of time before initiating a connection. Some malware may be sophisticated enough to utilize an entire application stack (e.g. not limited to a rendering engine or SIP message API). Some malware may employ a certain subset of browser components to navigate the Internet. Therefore, some embodiments may direct challenges to subsets of components.

According to some embodiments, active detection may challenge the necessary, and some optional, components and functions of browsers and SIP clients in order to verify the legitimacy or requesting applications. In addition, some embodiments may disrupt botnet Command-and-Control channels, preventing spam and data exfiltration.

Some malware may craft legal communication(s) that send or receive data employing a minimum of packets. When data may be contained within the header elements of a packet, the greater the amount of data that is embedded, the more likely a malformed packet may be created. Irregular structure(s) may be detected using using passive detection. Command and control (C&C) messages may be small and easily embedded in a request packet. Therefore, in order to disrupt C&C messages, embodiments of the present invention may employ techniques to prevent malicious requests packets from arriving at the destination.

In addition to HTTP request and SIP signaling packets, data streams may be used to convey data. Stenographic techniques encountered for images and other objects in web pages may be applicable to VoIP communication. Deep packet inspection techniques may be used to analyze packets that contain payloads. Signature- or anomaly-based detection may be applied to these packets. To foil this mechanism, malware may use secure protocols. Instead of analyzing the data, some embodiments of the present invention may question the client that is sending or requesting data. Furthermore, some embodiments may implement systems that analyze secure communications. Both methods may be used in some embodiment. A passive detection module may be employed to pre-screen traffic for the deep inspection module.

While spam may be widely regarded as an Internet nuisance, Spam over Internet Telephony (SPIT) may not have fully matured into a real problem for Internet users. However, SIP may provide as much potential for generating large amounts of traffic through multimedia (voice and video) and instant messaging (IM) spam as does email and phone spam. Some embodiments of the present invention may handle both types of spam by preventing the initial communication from completing by challenging the client.

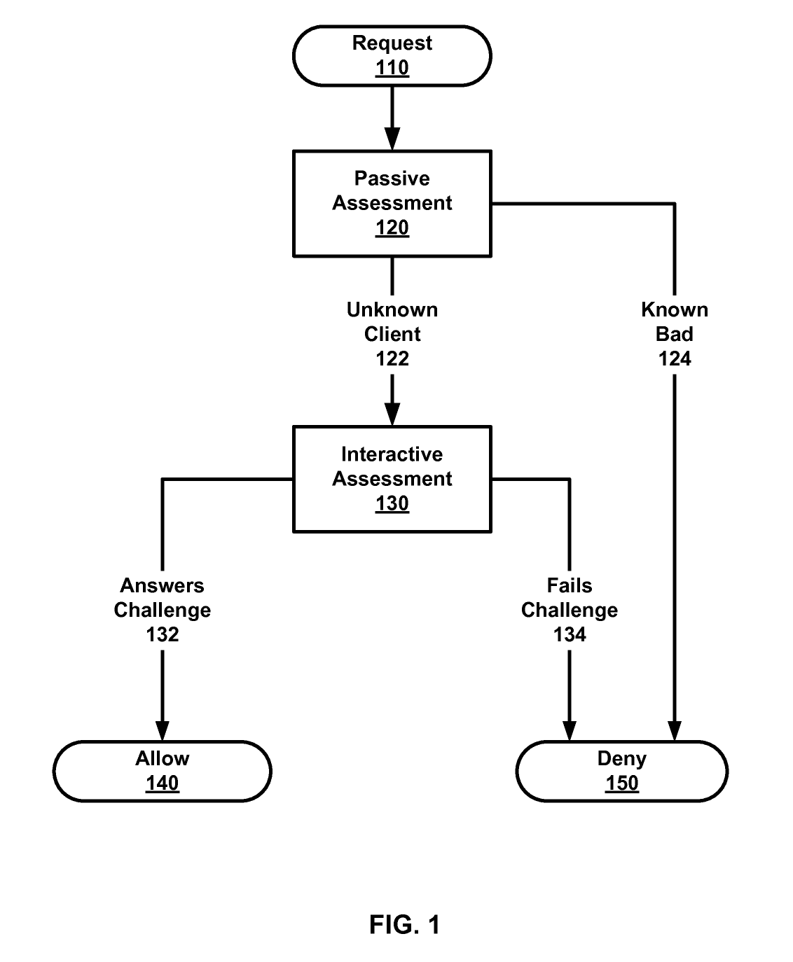

FIG. 1 is a flow diagram of an HTTP or SIP request through an aspect of an example embodiment of the present invention. Some embodiments of the present invention include two components: a signature-based passive detection module 120, and a module that actively challenges the client 130. For HTTP, HTTPS and SIP requests 110, the passive detection module may perform a passive assessment at 120. For example, the passive assessment 120 may read the headers of requests packets to identify whether the client is a known bad client 124 or whether the client is possibly legal 122 and in need of further examination. An interactive module may perform an interactive assessment at 130. For example, the interactive assessment 130 may challenge the client to perform before allowing a connection to proceed. For SIP, the interactive assessment 130 may also challenge the client during a call. Requests 110 from clients that answer the challenge correctly 132 may be allowed to pass to the intended recipient at 140. Requests 110 from clients that answer the challenge incorrectly 134 may be prevented from passing to the intended recipient at 150.

A design principle for at least some of the embodiments is that embodiments may be online and transparent to a user. It may not require a human to prove herself but may shift the onus of proof to the requesting application. Since the User-Agent field in browser and SIP requests may be specified or altered, some embodiments may not trust that a request is not generated by malware masquerading as a particular client. Some embodiments may also not depend on blacklists to provide timely information in zero-day attack situations. Therefore, some embodiments may employ network-level transparent proxies and/or non-disruptive queries to analyze network traffic and probe applications.

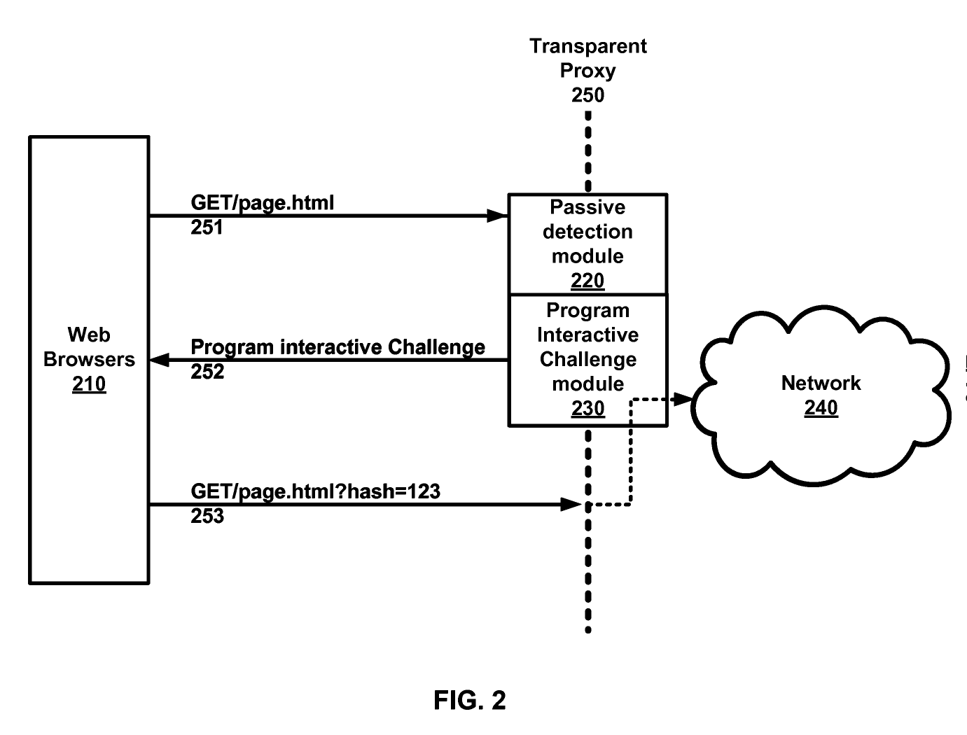

FIG. 2 is a block diagram showing the processing of an HTTP GET/POST request 251 as per an aspect of an example embodiment of the present invention. Some embodiments may employ a passive detection module 220 that analyzes the order of header elements in message request packets 251 to determine which client 210 is requesting or sending data. For example, some embodiments may analyze HTTP GET or POST requests 215 for browser 210 generated traffic. In Internet telephony, it may be common for communication to be relayed by another node. Therefore, in developing SIP client signatures, multiple architectures may be analyzed such as: direct calls between SIP clients, calls through a proxy or server, or the like. The headers of SIP INVITE requests may be analyzed though techniques applicable to other SIP request packets.

Some embodiments may employ an active module 230, referred to in some embodiments as a Program Interactive Challenge (PIC) system. PIC 230 may be triggered by the same request packets 251. Some embodiments of the present invention may include a transparent proxy 250 that redirects browser and SIP traffic to a network-level detection module which may be configured to store and read packet data, challenge the client, forward verified traffic 253 through the network 240, block suspect machines, or the like.

Example embodiment(s) will now be described. Passive and active modules for this example embodiment may be implemented using a mixture of standard desktops, laptops, virtual machines and smartphones. Signatures may be developed for a passive module without considering system performance such that a virtual machine used to test a Windows-based clients. VMWare Fusion 2 may be employed to run the Windows VMs on Mac Pro or MacBook Pro with 768 MB of RAM and shared 100 Mbps Ethernet connection. The same resource allotment may be employed for Ubuntu Jaunty VMs to create a multi-node SIP network, one of which may be used as a SIP transparent proxy. For cell phone browser testing, a MacBook Pro may act as a wireless router and forward traffic. Physical machines may be connected through a 1 Gbps switch, and nodes placed on a private network to minimize latency and unwanted traffic. For a production network, a Squid 3.1.8 proxy may be employed on a Ubuntu Lucid server with two dual-core 2.33 GHz Xeon CPUs, 16 GB of 667 MHz RAM, and two 500 GB drives in Raid 0 may be employed.

According to this example embodiment, passive and active modules may be employed on a gateway device. HTTP/S and SIP passive detection may be conducted by the same module and gateway device. In contrast, active modules may be employed on separate systems. The SIP PIC may be implemented as a single separate program. For HTTP/S, traffic may be proxied to an analysis module. To enable reading encrypted communications, the some embodiments may employ a version of Squid proxy later than 2.5. In some example embodiment, HTTPS communication may be terminated at a proxy so that headers may be read in clear text. Clear text request packets may be forwarded to ICAP server. The ICAP server may be a multi-thread, Python- and Javabased server that provides an API for constructing active challenges.

The need for a PIC may be demonstrated by analyzing a sample of malware. A sample population may be placed on copies of a Windows VM on a Dell R710 server with 72 GB of 800 MHz RAM and 2 quad-core Intel Xeon CPUs, and each malware executed by VM scripting for VMWare Workstation 7.1 for Linux. The malware may be allowed to execute for time periods such as 4, 15, and 30 minutes, and 1 hour. The traffic may be recorded and analyzed to identity which formed HTTP, HTTPS or SIP connections. A single copy of the Windows VM may be run with antivirus activated to find which malware may be detected and removed in the same time periods. Remaining unquarantined malware may be activated by scripting VMWare Fusion 2 to see if malware may defeat the example embodiment.

The performance of example challenge architecture(s) may be measured in real-world settings. For HTTP challenges, elapsed load times of webpages across the United States may be compared. A baseline between a node on George Mason University network, and 3 test sites on the West Coast, East Coast and Middle America may be established. The same sites may be loaded through the example active architecture. A similar test may be conducted by downloading binary files of varying sizes from geographically-diverse PlanetLab nodes. On PlanetLab, web servers may be hosted to serve the binary files and a comparison conducted in the aforementioned fashion. For these tests of the example embodiment, each of the nodes may employ virtualized hardware.

For evaluation of the SIP PIC example embodiment, a mixture of platforms may be employed with up to five nodes in a network. Direct SIP calls may be conducted between Windows clients on a VM, Mac OS X clients on a desktop or lap, Linux clients on a Jaunty VM, and a gateway machine running analysis modules. For SIP client-server testing, SIP servers may be created on each of the platforms mentioned. The performance of a single challenge and compound challenges may be measured to assess how the example embodiment might impact the user.

Passive Detection Module: According to some embodiments, a traffic analysis module may store and parse desired traffic flows. TCP-based communications may be broken into flows as there may be a definite end to a communication. The open-source tool tcpflow is an example program that may perform this function of copying TCP flow data, however, the example passive module may be required to analyze different transport protocols. Therefore, tcpflow may be modified to construct udp “flow” information. In an example embodiment, the modified version of tcpflow was called protoflow. An ability added in protoflow was the ability write flow information to memory as well as to disk.

According to the example embodiment, an analysis tool may access flow information from shared memory space. A high speed, scalable analysis tool may be implemented using Perl regular expressions pattern-matching. Signatures may be developed statically by analyzing request packets in Wireshark. Wireshark is a network protocol monitor available from Wireshark Foundation. Signatures may be verified by running traffic through the example passive module. This system may dynamically create signatures by maintaining a version list of existing clients, adding new clients and re-testing signatures after client or extension updates.

To analyze packets, a network may be constructed of virtual and physical machines running test bed operating systems, and a linux-based gateway machine running the example passive module. Clients may remain in their default configuration throughout testing. For each test browser, a signature of GET and POST requests may be developed for different content, page and file types.

For Sa IP client, two architectures may be tested. In one architecture, INVITE requests from direct connections between SIP end points may be analyzed. In a second architecture, an endpoint may be connected through a server or proxy and the INVITE requests that left the intermediate node may be analyzed.

To demonstrate the need for a more interactive system, the efficacy of traditional host security mechanisms may be tested. A sample of 604 zero-day and user-contributed malware may be obtained from Google and a Malware Domain List. The obtained malware may be run in Windows virtual machines under two, basic scenarios: 1) while host-based Symantec AntiVirus and Windows Firewall may be active to ascertain the effectiveness of AV signatures and rule-based security; 2) with no host-based security to find which malware generate HTTP, HTTPS or SIP connections when executed. The tests may include waiting over various time periods to see if malware attempts communication. This approach may be similar to virtual honeypots and establishs how long a honeypot may remain active in order to detect a majority of malware.

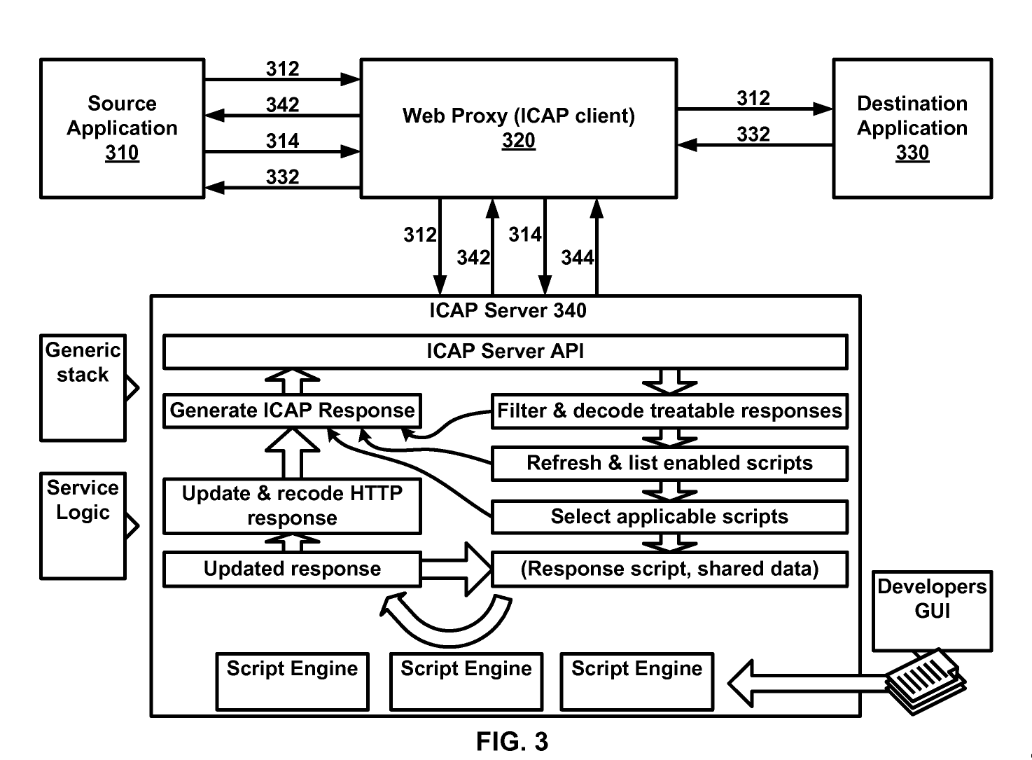

The example architecture of an active challenge embodiments is illustrated in FIG. 3. Source application 310 may generate a request 312 intended for destination application 330, for example an HTPP/S compliant application. Challenge packets 342 may be injected into a packet stream to invoke a function and/or component of source application 310. For HTTP/S, the challenge may be triggered by finding GET or POST in the message header of request 312. However, packets encrypted by unknown keys may not be decoded and parsed. In order to receive clear-text headers for web traffic, an example analysis module may consist of a proxy 320 that can terminate HTTPS communications. Received request packets 312 may be forwarded to a server 340 to be analyzed. An injection tool may create and issue a challenge 342 to requesting application 310. In summary, an example challenge system may consists of: (1) a Squid 2.5+—an open-source proxy for HTTP, HTTPS and FTP traffic; and (2) an ICAP server 340 may be an open source, Python-based API for applying rules and filters on Squid. The ICAP server 340 may returns a page with a Flash, JavaScript or HTML challenge 342 to an HTTP/S compliant source application 310.

The response to the challenge 314 may be forwarded by web proxy 320 to ICAP server 340. If the challenge response 314 is judged to be adequate by ICAP server 340, a message 344 may be sent to the Web Proxy 320 to allow the request 312 to pass to destination application 330. Destination application 330 may forward a response 332 to source application 310 through Proxy 320. In some embodiments, permission message 344 may be a copy of request 312. On other embodiments, permission message 344 may be a message telling proxy 320 to forward a stored copy of request 312 to destination application 330.

The performance of the example HTTP PIC architecture may be tested by simple website loading and/or downloading binaries, or the like. For simple loading, diversely-located websites throughout North America may be employed. Additionally, websites of varying content complexity may be tested to find how embedded elements incur overhead. An attempted to download executable files of 10, 100, and 1000 kilobytes may be made from six PlanetLab nodes located in North America, South America, Africa, Europe, Asia and Australia. For each test, a baseline of standard HTTP connections may be established, then repeated through the active challenge architecture.

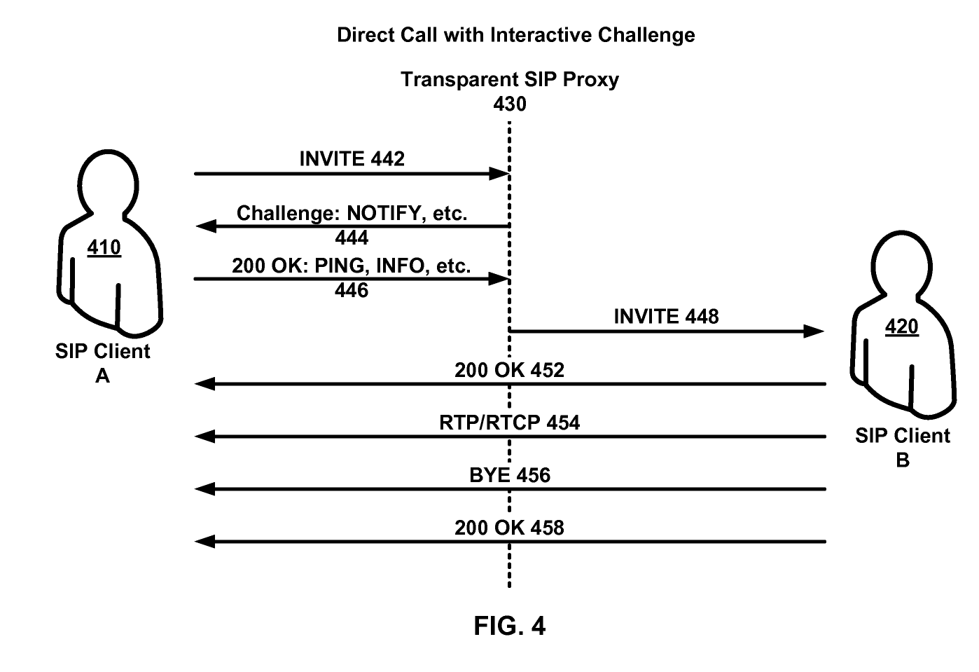

Example SIP PIC system embodiments may employ different components for gateway device(s) such as Squid that may not proxy VoIP traffic. Instead, a Ubuntu Linux -based machine that runs analysis and query tool(s) may be used. Example embodiments may employ the components in the example passive module and add an example C-based SIP injection tool, sinjector. IPtables rules may be created to queue SIP traffic. Using Libipq, Sinjector may remove SIP packets from the queue, analyzes them and inject an appropriate challenge. Example embodiments may maintain a table of hosts that may be allowed in order to make subsequent challenges. FIG. 4 illustrates a challenge under the SIP PIC architecture.

Though the overarching active challenge concept may be the same, the nature of SIP may allow more than one type of component to challenge. As VoIP communication may consist of signaling and multimedia protocols, a SIP active tool may be divided into two levels. The first level may leverage the signaling portion of SIP by sending generated SIP requests 442 from a first client 410 to a second client 420 client upon the initiation of a SIP call. There may be a number of requests packets employed in SIP communication. As the requests are optional, a client may not respond to such requests. In addition, the libraries and engines used by each client may determine what capabilities are available. The engine may respond to some or all of these example requests: INVITE 442, ACK, OPTIONS, BYE 456, CANCEL, NOTIFY 444, REFER, MESSAGE, INFO 446, PING 446, or the like. SIP client reactions may be tabularized to these requests. By carefully selecting a method for a challenge packet 444, a subset of methods requests may be derived that neither breaks the SIP connection nor requires user interaction or intervention.

Sinjector may determine whether the client responds, and analyze responses for correctness and timeliness. This challenge method may be disruptive in that it waits for client responses before forwarding the initial INVITE request 448. During this time, a legitimate user may be waiting, and the SIP client may re-issue the INVITE 442. Sinjector may simply drop all subsequent requests from any host being processing, and block any client that fails the test.

According to some embodiments, at the second level, it may be desired to challenge a SIP client in an established call. With mid-conversation challenges, efforts to invoke functions or force changes may often be disruptive. Some embodiments may mimics the HTTP challenge by leveraging functions necessary to encode and decode voice and video communication, namely codecs. For an example test bed system, concentration may be on audio codecs, but the technique may be applicable to all RTP traffic. To the suspect client, PIC may issue a non-disruptive request to change audio codec using an INVITE or UPDATE packet which initiates media loopback to a server, i.e. a copy of all subsequent RTP packets encoded in a codec according to a specified specification may be received. For example, a one-time 160-byte challenge encoded to GSM 6.10, G.711u, G.711a or Speex may be employed, depending on which codecs the client supports. If the returned re-encoded packet is incorrect, the call may be terminated and traffic from that host blocked. The following algorithm depicts the logic of an embodiment of an example SIP PIC system for the determining legal clients in sinjector.

01. while TRUE

| | |
|---|---|
| 02. | Queue packets destined for UDP 5060 |
| 03. | if packetᵢ == INVITE then |

| 04. | send OK to HOSTᵢ with CODECᵢ |
|---|---|
| 05. | send ACK to HOSTᵢ |
| 06. | send INVITE or UPDATE to HOSTᵢ with loopback for |
| | CODECⱼ |
| 07. | send active challenge to HOSTᵢ with CODECᵢ |
| 08. | await response from HOSTᵢ in CODECj with socket |
| | timeout |
| 09. | if TIMEOUT from HOSTᵢ |

| | |
|---|---|
| 10. | Drop INVITE packetᵢ |
| 11. | continue |

| | |
|---|---|
| 12. | end if |
| 13. | if receivedlegalresponse |

| | |
|---|---|
| 14. | Allow (re-inject) INVITE packetᵢ |
| 15. | Whitelist HOSTᵢ |

| | |
|---|---|
| 16. | else |

| | |
|---|---|
| 17. | Drop INVITE packetᵢ |
| 18. | Blacklist HOSTᵢ |

| | |
|---|---|
| 19. | end if-else |

| | |
|---|---|
| 20. | else |

| | |
|---|---|
| 21. | if HOSTi is whitelisted |

| | |
|---|---|
| 22. | Allow (re-inject) INVITE packetᵢ |

| | |
|---|---|
| 23. | else |

| | |
|---|---|
| 24. | Drop SIP packetᵢ |

| | |
|---|---|
| 25. | end if-else |

| | |
|---|---|
| 26. | end if-else |

27. end while

Evaluation of an example passive detection embodiment:

To validate the correctness of the client signatures for the example embodiment of the passive detection module, header element names may be enumerated, as well as the names of sub-elements within header fields, for each client and operating system tested. It may be considered whether the order of major head elements may be sufficient to uniquely identify a client and operating system pair considered, or if the order of its sub-elements is necessary to distinguish between clients. The correct detection of test web browsers and SIP clients may be tested.

Working on two example test beds, regular expressions for example embodiments of a signature-based detection module may be developed and verified. In a first set of tests, a Dell Precision or Mac Pro 4,1 desktop running Ubuntu Linux 8.04 and later, a Virtual Machine running Windows XP and a MacBook Pro running Mac OS X 10.6.x as hosts machines may be employed. An example embodiment of a passive detection module on a gateway machine running Ubuntu 8.04 or higher may be employed. A gateway machine OS may extend the capabilities of extent IDSes, many of which run on versions of Linux OSes. In a second example test bed, the architecture from test bed 1 may be reused, but a MacBook Pro may also be employed to act as a wireless router for mobile devices.

Through each iteration, at an ICAP server, flows into a shared memory may be read using the modified tcpflow. The example passive inspector may read from shared memory and analyze the packet headers. The example passive analysis test bed may analyze up to 1153.4 requests per second. However, the test bed may be most stable between 500 and 600 per second.

HTTP/S: A premise may be that the client and operating system influences the order of message header elements, however, one might be able to assume that HTTP GET or POST request packet structure vary only by these factors. From testing, it may be determined that requesting a JSP page results in different sub-element order than requesting an HTML page, as does requesting an image over an embedded flash object.

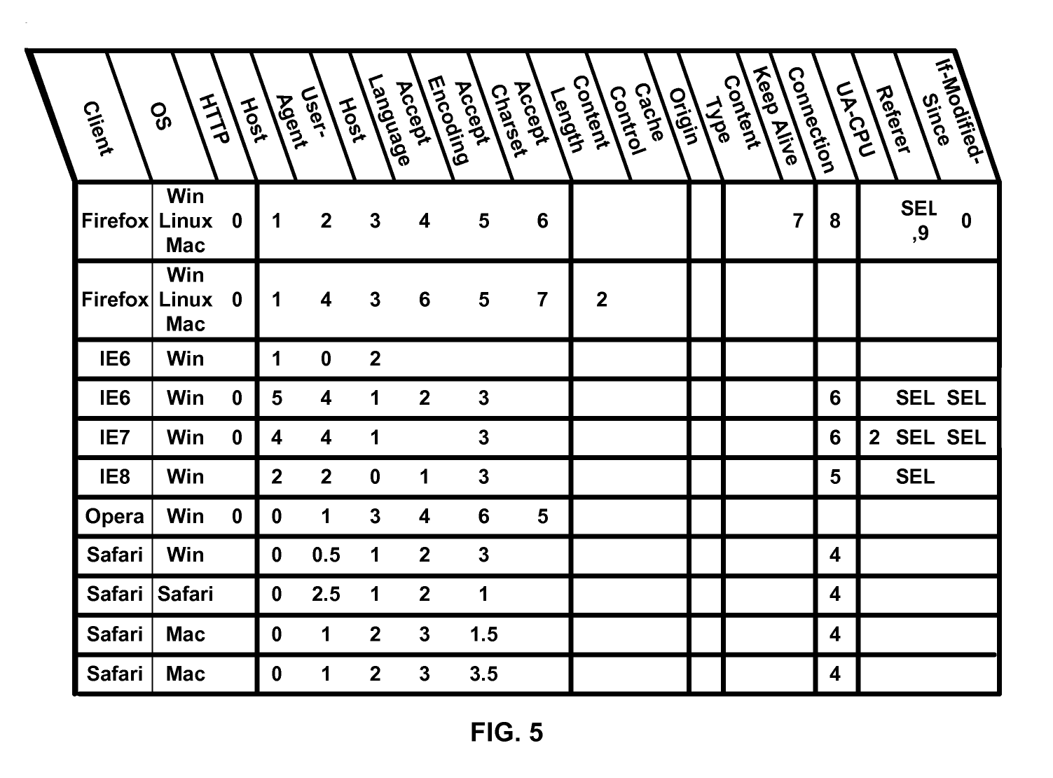

Experiments may be conducted to find unique signatures that account for minor variances introduced by different content or page types without compromising the effectiveness of some embodiments. A feature set of sixteen header elements and sub-elements may be identified: HTTP, Host, User-Agent, Accept, Accept-Language, Accept-Encoding, Accept-Charset, Content-Length, Cache-Control, Origin, Content-Type, Keep-Alive, Connection, UA-CPU, Referrer, If-Modified-Since, and Cookie. Any sub-elements that introduced unnecessary granularity to the signature set may be discarded. Remaining signatures are tabularized in FIG. 5.

FIG. 5 illustrates a table of eleven signatures derived for a passive signature database. As the Cookie element may typically occurs at the end of the header, it is not included in this table; however, for the lone case of Android 2.1 browser, the Cookie header occurs at position number six. Fields marked “SEL” indicate that the header element exists in a select number of packet; furthermore, the position of this element may be indicated.

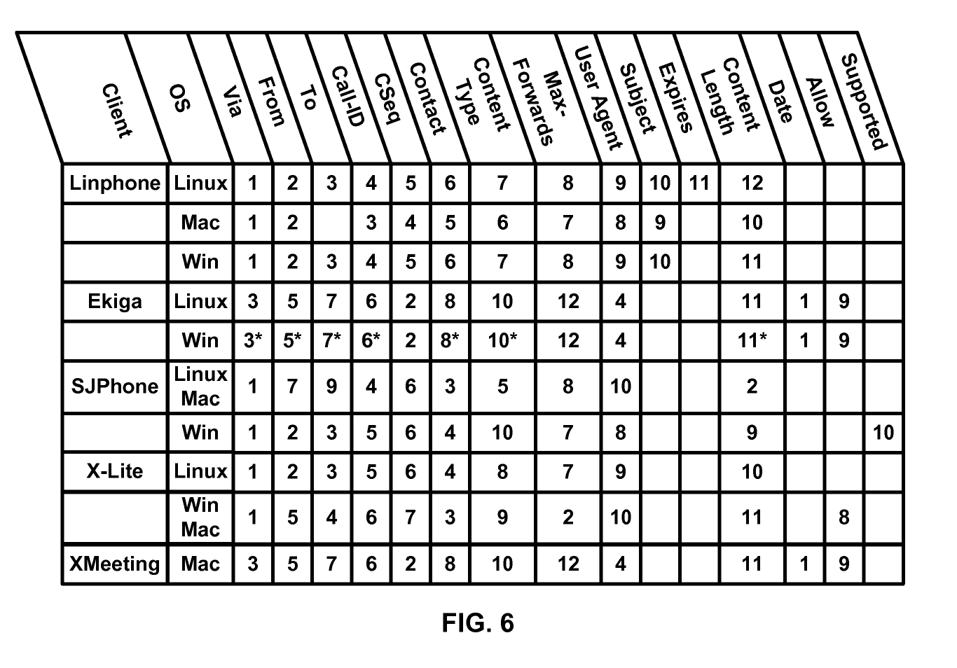

SIP: Similarly to the HTTP/S analysis, it may be determined whether factors other than client and operating system introduce variance in SIP INVITE message header element order. Unlike HTTP, while the type of recipient node and requested codecs differ, they may result in no variance in element or sub-element order. However, due to the higher prevalence of signature overlap between clients and operating systems, certain sub-elements, like those in the ‘Via’ header, may be necessary to distinguish between applications. Signatures may be developed from a feature set of fifteen, INVITE header elements and sub-elements: Via, Date, From, To, Call-ID, CSeq, Contact, Content-Type, Content-Length, User-Agent, Max-Forwards, Subject, Expires, Allow, Supported. Furthermore, the sub-element order of the ‘Via’ and ‘Contacts’ header fields may be considered. FIG. 6 illustrates major header element order(s) of test SIP clients.

Analysis: Passive application fingerprinting may be sufficient to detect simple malware; however, this approach may be defeatable by maintaining a database of properly-formatted responses. If the libraries or message APIs are available to the malware, passive detection may be inadequate by itself.

Evaluation of an example interactive challenge embodiment:

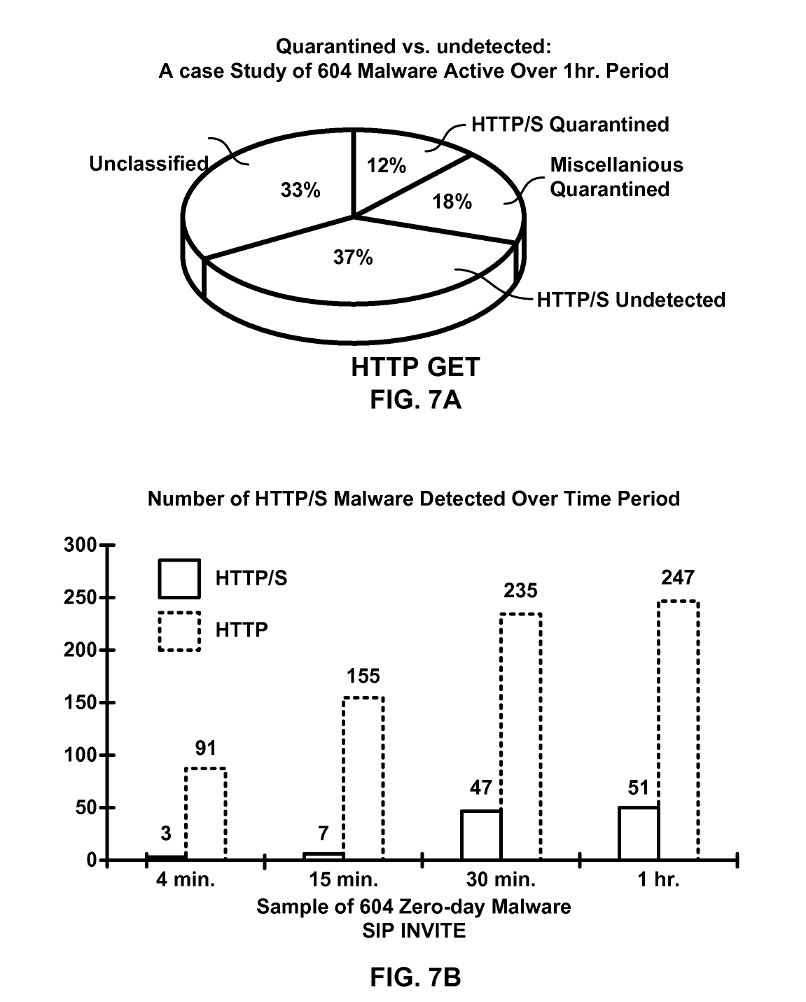

A sample of zero day malware may be obtained from Google and a Malware Domain List in order to simulate a real world, worst-case scenario of malware infection. The percentage of these malware that form HTTP, HTTPS and SIP connections to external hosts may be quantified by running each malicious file in a virtual machine over different durations and analyzing the traffic. This may simulate the work in analyzing malware behavior in virtual honeypots and sandboxes. The results of example sample evaluations are presented in FIG. 7A and FIG. 7B.

Two assumptions may be made about the simulated network: 1) it may allow outgoing web and Internet Telephony traffic by default; and 2) the example interactive module may pre-screen traffic before it reaches other network-level security mechanisms. Therefore, only the effectiveness of traditional firewall and antivirus mechanisms in detecting, blocking and removing the malware at the host level may be tested, and not the performance of network IDS in detecting malware. The ability of the remaining malware that eluded traditional mechanisms to defeat the example PIC system may be assessed. Some subset of remaining malware may be written to detect and evade CMs, but may be detected and challenged by the example active module embodiment(s).

HTTP/S Challenge: From testing, it was found that none of the malware was able to decode presented challenges and complete their connections. This bolsters the assumption that most current malware may not be sophisticated enough to precisely simulate protocols, or call browser functions and components. As such, experiments focused on quantifying the overhead introduced by example PIC embodiments for various challenge types.

First, it was demonstrated the effect of an example embodiment on simply loading a website. Each element in a page may not result in a PIC challenge, however, as each request is analyzed, PIC may introduce overhead. Four Computer Science department web servers chosen for locational diversity and website complexity (i.e. containing plain text, images or active content) may be employed. Test websites include computer science department pages of: George Mason—minimalist, local page that is largely plain html; College of New Jersey—East Coast site with flash content; University of Kansas—Middle America page with embedded objects; and Berkeley—minimalist, West Coast site.

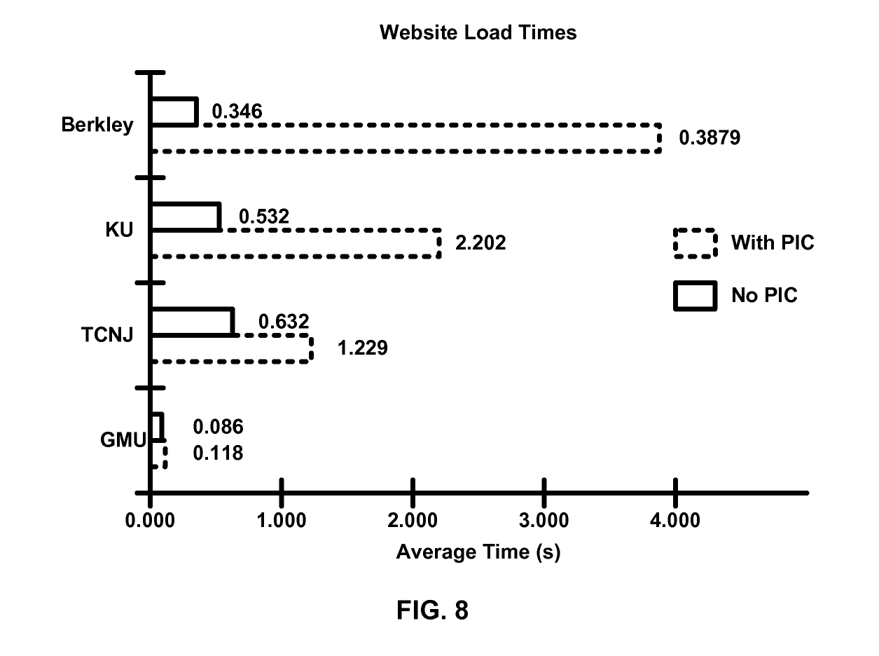

HTTP/S Challenge Performance: A baseline download duration for each site was established. An attempt to load each site through our PIC architecture was conducted. The comparison of load times is illustrated in FIG. 8.

It was expected that a minimalist website hosted on premise would incur negligible routing overhead, as such, loading the GMU department page represents most closely the overhead introduced by the example active architecture. However, the converse effect was observed. Due to caching by the Squid proxy, the example system reduces the average time to load a webpage.

An attempt to download a potentially malicious file was conducted, an executable, through the example an interactive challenge architecture embodiment.

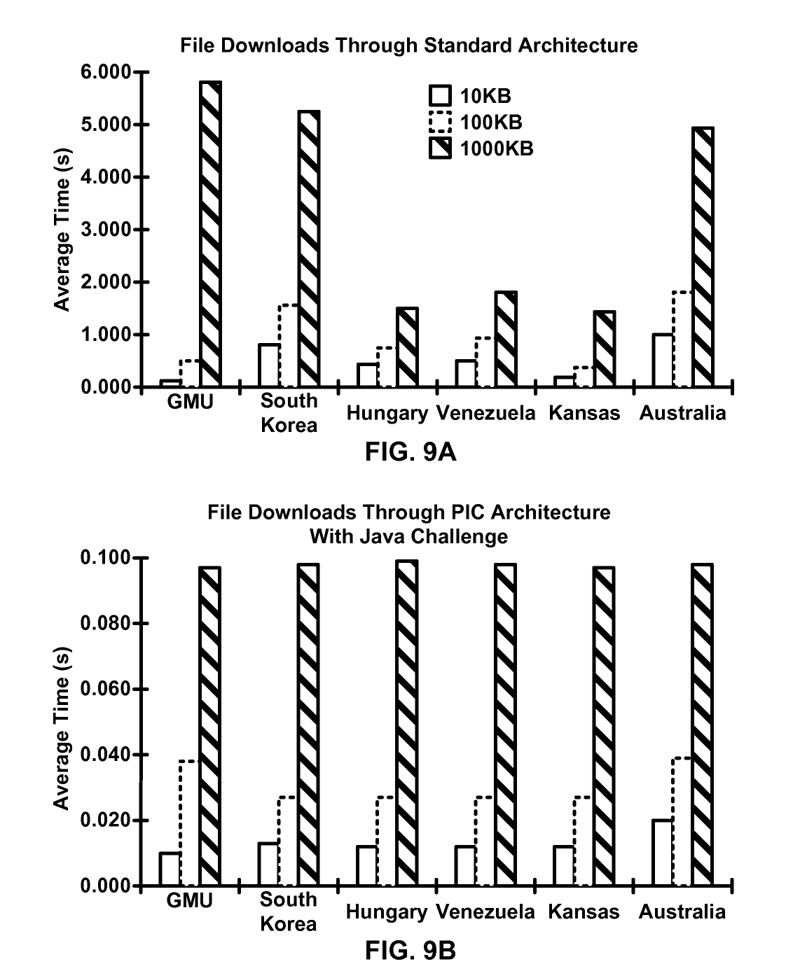

A baseline of download times for files of size 10 KB, 100 KB and 1000 KB, from five geographically-diverse nodes, and one local node was established. These downloads were repeated through an example embodiment of a PIC architecture in which each GET or POST attempt was issued an HTML redirect, Flash or Javascript challenge. The comparison of standard elapsed times versus time through the example architecture is presented in FIG. 9A and FIG. 9B. In only one instance was an overhead created. For the 10 KB file hosted on the GMU server, the example PIC architecture embodiment with a Flash challenge added 0.137 s (or 265%) overhead. However, on average, the example architecture reduced download times due to Squid caching. The most significant decrease occurred using the example architecture with a Javascript challenge which reduced transfer times by 97.

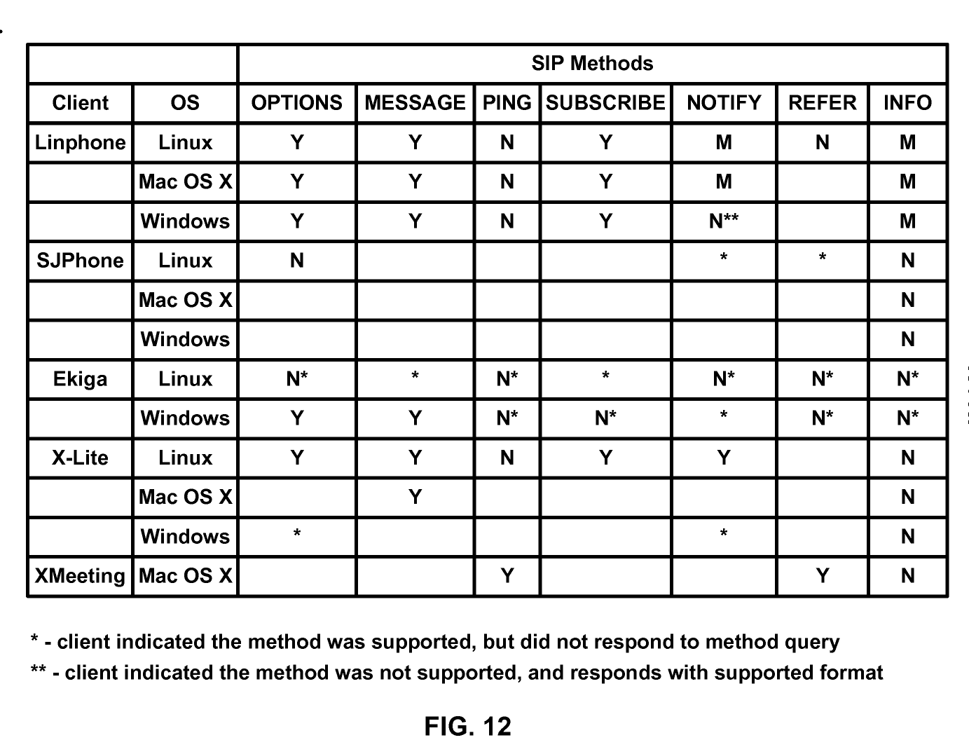

SIP Challenge: There may be two levels of interative challenges issued to SIP clients in experiments. In a first scenario, the SIP method queries supported by SIP libraries, like libosip and eXosip, may be leveraged. SIP methods which do not break the call may be enumerated so that queries remain transparent to the user. In addition, by the protocol specification, the client may identify which methods it supports in the INVITE packet. A test bed may be created in which an example PIC gateway embodiment device intercepts SIP INVITE requests and issues each request in a table to test clients. FIG. 12 tabularizes whether clients responded to method request(s). Furthermore, whether a client mighty successfully respond to a compound challenge may be identified, i.e. a sequence of method requests. Client identification by a passive module may be combined with a capabilities matrix to know which challenges, and order of challenges, may be issued to a given SIP client. Failure to reply to challenges may suggest misidentification or malicious behavior of the requesting client.

The second level of SIP challenge may occur while the call is in progress. Similar to the PIC challenge embodiment for browsers, the client may be challenged to call a function. For SIP, the use of codecs may be exploited to cause the SIP client to change audio encoding, and to replicate the voice stream to a host that verifies the specified codec.

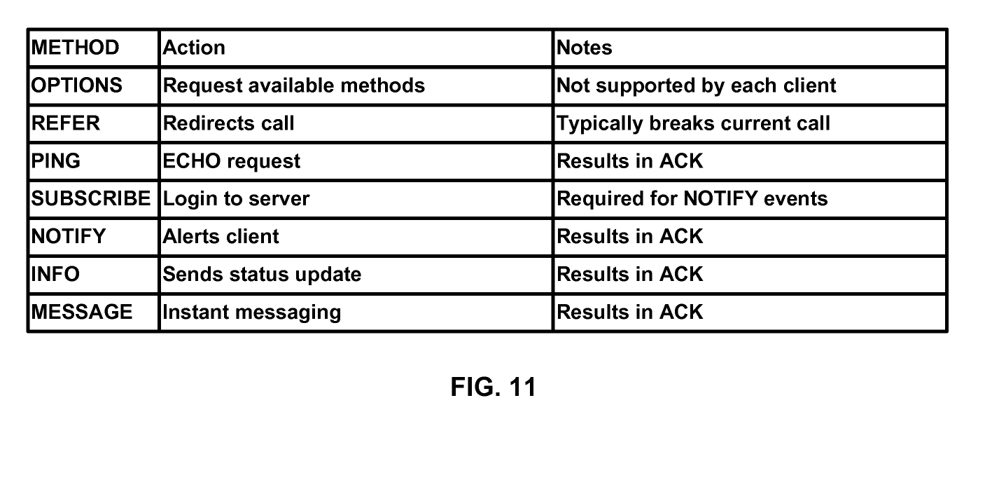

SIP Challenge Performance: The performance of the SIP challenge embodiment may be evaluated for a sample of three clients, on three operating systems. Traffic was dumped at the gateway device. Wireshark may be employed to find call duration—between sending an INVITE packet and receiving an OK or ACK packet from the recipient. Clients capable of responding to at least two challenges, and as many as four, may be chosen from the table in FIG. 11. At least two clients may be tested on each operating system. Each client may remain in its default configuration.

SIP challenges may occur at two points of a SIP call: at the inception of the conversation, or mid-conversation. In a first experiment, the challenges may evaluated at the beginning of a call. A baseline measurement for SIP call setups may be established. The latency introduced by single and compound challenges of two to four queries may be measured.

The order may be is important—a SUBSCRIBE request may fail if INVITE and acknowledgement are not received, as such it is ineligible for a one-challenge test. From the table, except XMeeting and SJPhone, it was derived that most of the test clients may respond to the OPTIONS and MESSAGE requests. Therefore, these may be made the first two queries in determining latency. For XMeeting, PING may be employed as an initial request; SJPhone may not be a candidate for a challenge embodiment, as it may not respond to a query. After the first challenge, each subsequent challenge may be issued in a compound manner, i.e. two queries may be issued before the INVITE is allowed, in the next test, three may be issued before forwarding, and so on, with the applicable requests for that client. A four-challenge compound query may be employed for the sole client that may respond—Linphone for Linux.

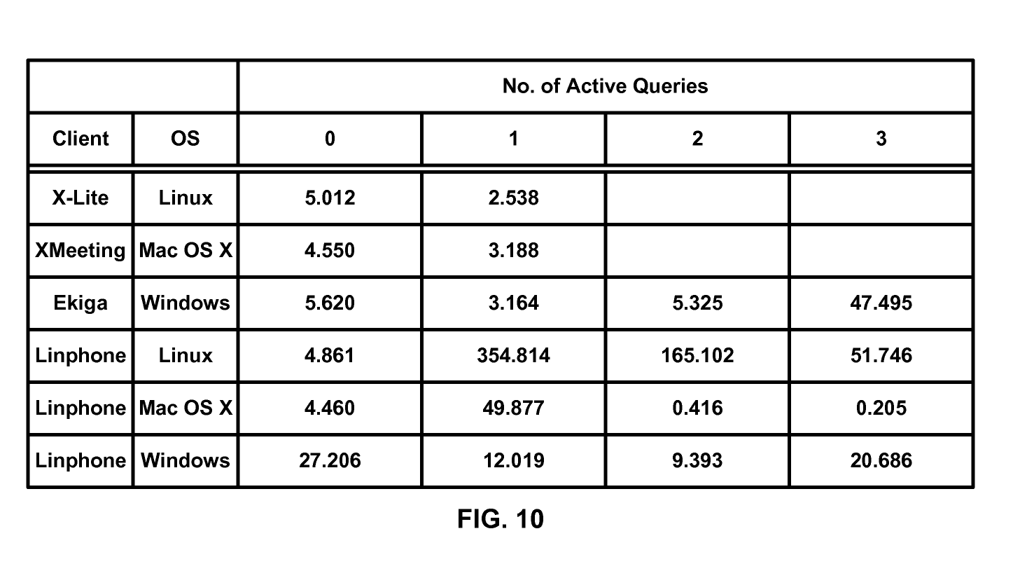

For compound challenges, as order may be important, challenges may be issued in an order that would not prematurely terminate or suspend the call. For this reason, SUBSCRIBE and REFER queries may occur as a later request in compound queries. In general, queries in compound requests may be carefully chosen from the matrix. FIG. 10 depicts the overhead introduced by the example PIC embodiment. It shows that for Linphone on Mac OS X and Linux, the OPTIONS packet resulted in the most significant overhead of all query packets chosen, to the magnitude of 10 to 90 times longer than the baseline the elapsed time (ET). For other clients, a single challenge results in a fractional increased in latency, of 0.5 to 0.9 longer than baseline times.

Though X-Lite may be capable of responding to a number of challenges, it was discovered that one challenge may be the practical upper limit. Also, for compound challenges that begin with an OPTIONS query, the second challenge may incur far less latency than the initial challenge. This is particularly true for Linphone on Mac OS X for which the latency for MESSAGE is over a hundredth of the response time to OPTIONS. For the Linux version, latency may be halved, and on Windows there is approximately 25% less E.T. We bare in mind that, as MESSAGE is the type of request for which information is meant to be delivered to the user, some of the E.T. may be in how the message is rendered to the user-echo command line, print in open window, open a new window, etc.

Typically, SUBSCRIBE requests may be used in compound challenges of three or more challenges. Test bed SIP clients may respond to SUBSCRIBE requests with different types and amounts of packets. As such, the SUBSCRIBE challenge may incur latencies consistent with this variance; however, the maximum latency incurred by three challenges may be less than 0.6 seconds, which may be difficult for a user to perceive. For a four-method compound challenge, the average setup completion time may be approximately 4.025 seconds. This lapse may be far more noticeable by a user. It may be considered that, for clients like X-lite that employ ringing audio, four seconds may be comparable to one “telephone ring.” For such clients, a compound challenge may be less, however, an implementation may be capped at three challenges in a session.

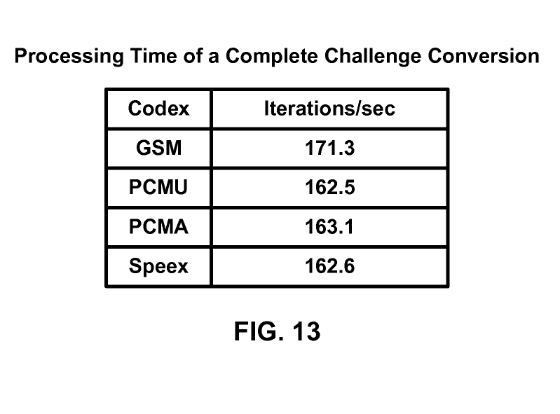

An expense of a codec challenge embodiment may happen between steps 446 and 448 of FIG. 4 in constructing an appropriate challenge. For each iteration, the INVITE packet may be parsed to construct three signaling packets, create a one time challenge and encode the signaling packets in a desired codec. On the Ubuntu proxy, this section may be evaluated for each test codecs over 5 minutes using 80 threads. The results are presented in FIG. 13.

Analysis and Limitations: It may be expected that website load times increase with distance, however, proxy caching may negate this effect. In FIG. 8, a performance improvement may be seen with Kansas University, and even greater improvement with Berkeley. Given that some embodiment(s) may be typically faster than baseline times, any overhead that packet inspection may introduce may be subsumed. Additionally, even when some embodiment(s) introduces overhead, for HTTP and SIP, it may not impact negatively on the user experience.

Some example embodiments may not validate browser plugins and extensions, such that if there is a malicious component that may leverage the complete stack, it may defeat PIC. A related matter is that ubiqitous, non-malicious extensions and components like Javascript and CSS may be present in order to decode challenge(s). The more components that may be present, the more able embodiment(s) may be able to issue compound challenges. Through traffic analysis, it may be possible to glean which components may be supported.

For Linphone on Windows, the E.T. for each added request may be fairly constant, at about 10 ms. This average may be high when compared to certain SIP request processing times, like MESSAGE, but may be more efficient when processing requests like SUBSCRIBE. Ekiga on Windows may show no such consistency. Extrapolating, the lag may be generated by individual client programming, and not by any common libraries or functions. The same processing variance may be true between clients on the same operating system, for Mac OS X and Linux. From these results, one might extrapolate that the response time of certain queries may be used in identifying a client.

Necessarily, PIC may increase the amount of traffic on a network, particularly in the case of a compound challenge or media loopback. There may be some threshold at which the system and network performance may be degraded.

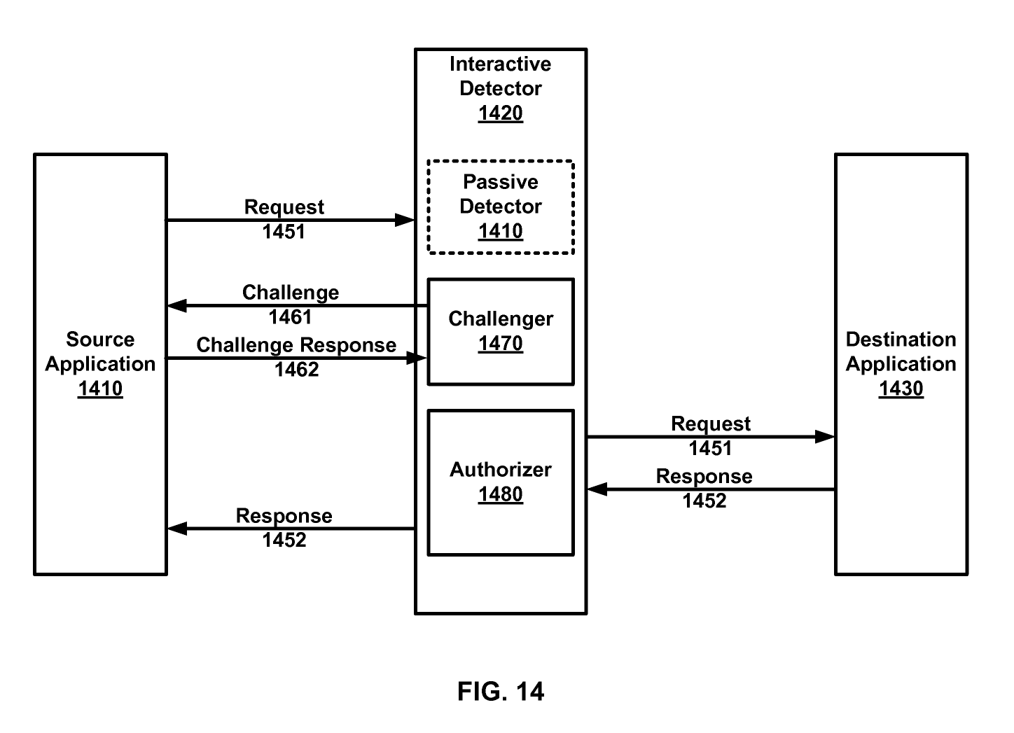

FIG. 14 is a block diagram of an interactive detector 1420 that may include a challenger 1470 and an authorizer 1480 as per an aspect of an embodiment of the present invention. The challenger 1470 may send a challenge 1461 to a source application 1410 in response to an intercepted request 1451 intended for a destination application 1430 from the source application 1410. The challenge 1461 may be configured to invoke an expected challenge response 1462 from component(s) of the source application 1410. The authorizer 1480 may allow the request 1451 to proceed to the destination application 1430 if a received challenge response 1462 generated by the source application 1410 satisfies the expected challenge response. A passive detector 1410 may be configured to allow the request 1451 to reach the challenger 1470 when the request satisfies a pre-filtering condition.

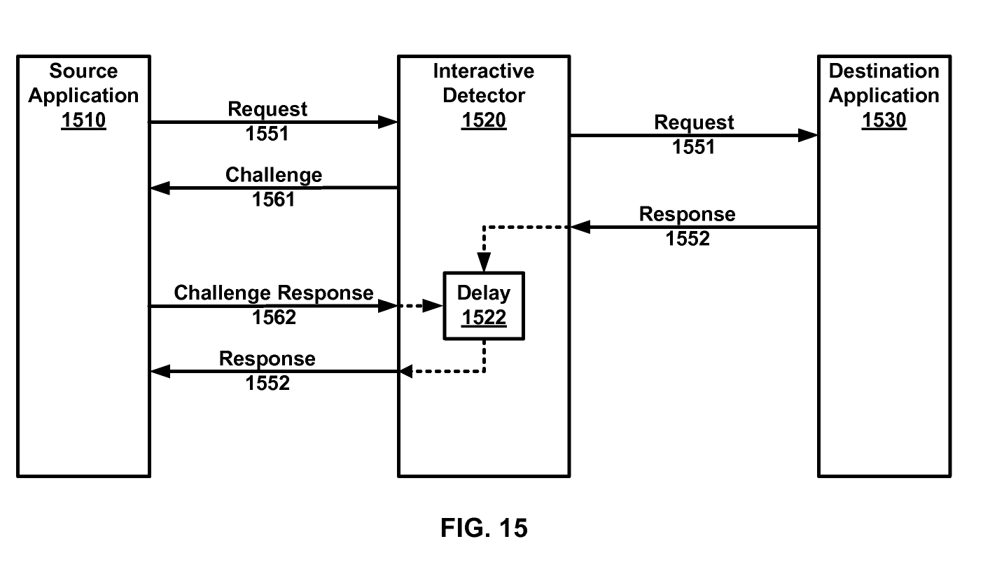

FIG. 15 is a block diagram of an alternative embodiment of an interactive detector 1420. As illustrated in this example embodiment, a source application 1510 may send a request 1551 to destination application 1530. Interactive detector 1520 may intercept and subsequently forward this request 1551 to destination application 1530. The interactive detector 1520 may send an active challenge 1561 to the source application 1510 in response to receiving request 1551. When destination application 1530 responds with a response message 1552, interactive detector 1520 may delay 1520 forwarding response message 1552 to source application 1510 until a valid challenge response 1562 is received from source application 1510.

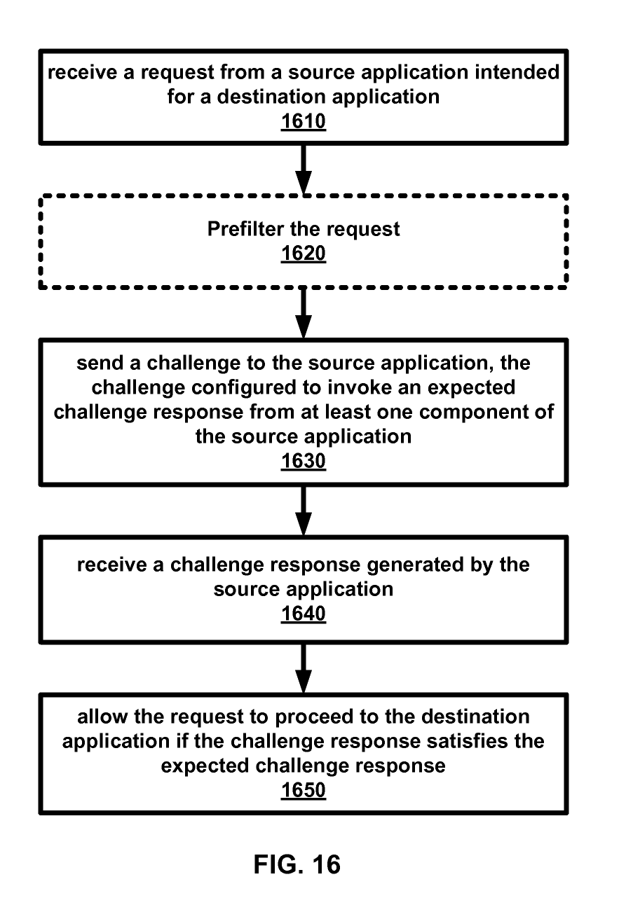

FIG. 16 is a flow diagram of an interactive malware detector process as per an aspect of an embodiment of the present invention. The process may be implemented, at least in part, as a non-transitory computer readable medium including computer readable instructions configured to cause one or more processors to detect malware. One skilled in the art will recognize that the process may have alternative embodiments such as being implemented using programmable hardware such, but not limited to: application-specific integrated circuits (ASICs), field programmable gate arrays (FPGAs), and complex programmable logic devices (CPLDs) or the like.

According to some embodiments, a request may be received from a source application intended for a destination application at 1610. The request may include, but not limited to one of the following types of requests: a SIP request, an http request, an https request, an ftp request, an IMAP request, a pop request, or the like. According to some embodiments, request(s) may be received a proxy.

According to some embodiments, request(s) may be pre-filtered at 1620. In some embodiments, the pre-filtering may be performed by a pre-filtering stage. Example filtering may include determining if the request satisfies a predetermined format. Example filtering may include determining if the request satisfies a known signature.

The source application and destination application may reside on different machines or on the same machine. The source application and/or the destination application may reside on a virtual machine or a physical machine. The source application may reside on a client machine and/or a host machine.

According to some embodiments, a challenge may be sent to the source application at 1630. The challenge may be configured to invoke an expected challenge response from at least one component of the source application. The challenge may be configured to test for at least one expected characteristic of the source application protocol and/or the source application functionality.

Challenge(s) may include, but not limited to, one of the following types of challenges: a request for a calculation, a request for a programed operation, a request intended to generate a specific error code, a request to translate data, a java challenge, a flash challenge, an html challenge, a redirect challenge, or the like. Component(s) may include, but not limited to one of the following types of components: a javascript component, an html component, a flash component, a SIP component, or the like.

According to some embodiments, challenge response(s) generated by the source application may be received at 1640. The expected challenge response(s) may include, but not limited to, at least one of the following types of challenge responses: a calculation result, a result of a programmed operation, a specific error code, translated data, a web page including java, a web page including flash, a redirected web page, an expected type of data, or the like.

The request may be allowed to proceed to the destination application if the challenge response satisfies the expected challenge response at 1650.

According to some embodiments, a non-transitory computer readable medium may include computer readable instructions configured to cause one or more processors to allow a received request from a source application intended for a destination application to proceed to the destination application if a component of the source application generates a challenge response that satisfies an expected challenge response in reply to a challenge from the one or more processors.

According to some embodiments, an interactive detector may include one or more processors configured to intercept and allow a request from a source application intended for a destination application to proceed to the destination application if a component of the source application generates a challenge response that satisfies an expected challenge response in reply to a challenge from the interactive detector.

Some embodiments for identifying malware downloads and malicious transmissions have been disclosed. The embodiments may employ subsystem(s) that may be real-time and transparent to the user. According to some embodiments, a passive detection module may analyze request packets. Some embodiments of the passive detection module may rely on the consistency in header element order to apply signatures. HTTP, HTTPS and SIP transmissions using regular expression pattern matching may be employed to determine the legitimacy of a client. Some passive system embodiments may not rely simply on the content of the User-Agent field, nor query any components of a browser. Some embodiments of an active challenge subsystem, PIC, may be employed to query a client on attempt(s) to download or send information. Some embodiments may challenge application(s) to call functions that should exist for legitimate conversation. Failing this, the communication may be broken.

For some test clients, signatures may be derived that may be unique where possible. The worth of the approach of some embodiments may be demonstrated by quantifying the effectiveness of other anti-malware mechanisms on zero-day malware. Some active challenger embodiments may be employed for protocols such as, but not limited to: HTTP, HTTPS and SIP communications. Specifically, connections of application(s) that may not be able to prove their identity may be broken. Results confirm that PIC may be a low-latency, lightweight solution. In worst-case simple communication tests, PIC may introduce approximately 0.6 s and 0.7 s overhead, for HTTP and SIP, respectively. In file download tests, leveraging the caching ability of Squid Proxy may make PIC more efficient than standard downloads.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, punched cards and paper tapes, optical disks, barcodes, magnetic ink characters and/or the like.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on detecting attacks when using applications such as browser and/or streaming operations on operating systems such as Liux, Windows and Mac OS. However, one skilled in the art will recognize that embodiments of the invention could be used with other types of applications such as proprietary data transfer applications, secure transaction applications, or the like. Similarly, one skilled in the art will recognize that embodiments of the invention could be used with other operating systems such as Android, Simbian, Blackberry OS, iOS or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1) A non-transitory computer readable medium including computer readable instructions configured to cause one or more processors to perform a process comprising:
a) receiving a request from a source application intended for a destination application;
b) sending a challenge to the source application, the challenge configured to invoke an expected challenge response from at least one component of the source application;
c) receiving a challenge response generated by the source application; and
d) allowing the request to proceed to the destination application if the challenge response satisfies the expected challenge response.

2) The non-transitory computer readable medium according to claim 1, wherein the request is one of the following:
a) a SIP request;
b) an http request;
c) an https request;
d) and ftp request;
e) an IMAP request; and
f) a pop request;

3) The non-transitory computer readable medium according to claim 1, wherein the source application and destination application reside on different machines.

4) The non-transitory computer readable medium according to claim 1, wherein the source application and destination application resides on the same machine.

5) The non-transitory computer readable medium according to claim 1, wherein at least one of the source application and destination application reside on a virtual machine.

6) The non-transitory computer readable medium according to claim 1, wherein at least one of the source application and destination application reside on a physical machine.

7) The non-transitory computer readable medium according to claim 1, wherein the source application resides on one of:
a) a client machine; or
b) a host machine.

8) The non-transitory computer readable medium according to claim 1, wherein the challenge includes at least one of:
a) a request for a calculation;
b) a request for a programed operation;
c) a request intended to generate a specific error code;
d) a request to translate data;
e) a java challenge;
f) a flash challenge;
g) an html challenge; or
h) a redirect challenge.

9) The non-transitory computer readable medium according to claim 1, wherein the challenge is configured to test for at least one expected characteristic of at least one of:
a) the source application protocol; and
b) the source application functionality.

10) The non-transitory computer readable medium according to claim 1, wherein the expected challenge response includes at least one of the following:
a) a calculation result;
b) a result of a programmed operation;
c) a specific error code;
d) translated data;
e) a web page including java;
f) a web page including flash;
g) a redirected web page; and
h) an expected type of data.

11) The non-transitory computer readable medium according to claim 1, wherein the component includes at least one of:
a) a javascript component;
b) an html component;
c) a flash component; and
d) a SIP component.

12) The non-transitory computer readable medium according to claim 1, further comprising pre-filtering the request.

13) The non-transitory computer readable medium according to claim 1, wherein the request passed a pre-filter stage.

14) The non-transitory computer readable medium according to claim 1, wherein the request satisfies a predetermined format.

15) The non-transitory computer readable medium according to claim 1, wherein the request satisfies a known signature.

16) The non-transitory computer readable medium according to claim 1, wherein said receiving the request includes receiving the request through a proxy.

17) A non-transitory computer readable medium comprising computer readable instructions configured to cause one or more processors to allow a received request from a source application intended for a destination application to proceed to the destination application if a component of the source application generates a challenge response that satisfies an expected challenge response in reply to a challenge from the one or more processors.

18) An interactive detector comprising one or more processors configured as:
a) a challenger configured to send a challenge to a source application in response to an intercepted request intended for a destination application from the source application, the challenge configured to invoke an expected challenge response from at least one component of the source application; and
b) an authorizer configured to allow the request to proceed to the destination application if a received challenge response generated by the source application satisfies the expected challenge response.

19) The interactive detector according to claim 18, further comprising a passive detector configured to allow the request to reach the challenger when the request satisfies a pre-filtering condition.

20) An interactive detector comprising one or more processors configured to intercept and allow a request from a source application intended for a destination application to proceed to the destination application if a component of the source application generates a challenge response that satisfies an expected challenge response in reply to a challenge from the interactive detector.
